(19) United States
(12) Patent Application Publication
(10) Pub. No.: US 2014/0352125 A1
(43) Pub. Date: Dec. 4, 2014

(54) METHOD AND APPARATUS FOR RETAINING TABLET COMPUTER

(71) Applicant: Oswaldo Duran, Milltown, NJ (US)

(72) Inventor: Oswaldo Duran, Milltown, NJ (US)

(21) Appl. No.: 13/903,205

(22) Filed: May 28, 2013

(51) Int. Cl. G06F 1/16

(52) U.S. Cl. CPC G06F 1/1626
USPC 29/428; 248/121; 248/125.1; 361/679.56

(57) ABSTRACT

An apparatus comprising a base, an upright device having a top and a bottom, and a retaining device, for retaining a portable electronic device. The base may be attached to the upright device, at an angle. The retaining device may be attached to the upright device. The retaining device may include a first section which extends over the top of the upright device and over the base. The retaining device may include a second section connected to the first section, extending from the first section towards the bottom of the upright device. The upright device may be held in an inclined orientation with respect to the base without being supported by the retaining device. The base may have a plurality of channels, each extending a majority of a width of the base, wherein the base is attached to the bottom of the upright device along the width of the base.

### FIELD OF THE INVENTION

This invention relates to improved methods and apparatus concerning retaining tablet computers and other portable electronic devices.

### BACKGROUND OF THE INVENTION

U.S. Published Patent Application No. 2009/0179132 to Qin et. al. provides a computer laptop stand including a front panel 1, a base 2, and a supporting plate 3. (Qin et. al., pg. 2, paragraph 25). The front panel 1 is connected to the base 2 so that one can pivot with respect to the other, and the supporting plate 3 is pivotally connected to the front panel at an end 5, such that the supporting plate 3 projects out from the back of the front panel 1. (Id.) A locating end 6 of the supporting plate 3 can be placed in different locating members 7 to set a particular orientation of the front panel 1 with respect to the base 3. (Id.) Qin et. al. discloses placing a computer keyboard of a laptop computer on the front panel 1, so that the keyboard is inclined based on the incline of the front panel 1. (Qin et. al., FIGS. 3-4).

U.S. Published Patent Application No. 2013/0009024 A1 to Liu provides a foldable supporting stand for a portable electronic device such as a tablet personal computer. (Liu, pg. 1, paragraph 19). Liu provides front legs 3 that are adapted to hold an electronic device, and are coupled to a base body 2. (Liu, pg. 1, paragraphs 19-22). The base body 2 is foldably coupled to a rear leg 4, which projects out from the back of the base body 2. (Id.)

U.S. Pat. No. 7,540,466 to Yang provides an adjustable stand 101 for electronic devices. (Yang, pg. 2, lines 39-40). The adjustable stand 101 includes a main body 1, a first support frame 4, and a second support frame 8. (Yang, col. 2, Ins. 39-63). The first and second support frames 4 and 8, respectively, both project out from behind the main body 1, and rotate with respect to the main body 1 to set an inclined orientation. (Yang, col. 4, Ins. 17-33; FIGS. 6B-6D)

U.S. Published Patent Application No. 2007/0152633 A1 to Lee provides a cradle 110 into which a portable electronic appliance 105 can be mounted. (Lee, pg. 1, paragraph 22).

U.S. Published Patent Application No. 2013/0075543 to Krohn provides an adjustable stand assembly 100 having an adjustable kickstand assembly 120 with kickstand element 130 projecting from the back of a support frame 102 for a portable electronic device. (Krohn, pg. 2, paragraph 26, FIGS. 2 and 4).

### SUMMARY OF THE INVENTION

In at least one embodiment, an apparatus is provided comprising a base, an upright device having a top and a bottom, and a retaining device. The base may be attached to the bottom of the upright device, such that the upright device is at an angle with respect to the base. The retaining device may be attached to the upright device. The retaining device may include a first section which extends over the top of the upright device and over the base. The retaining device may include a second section connected to the first section, wherein the second section extends from the first section towards the bottom of the upright device. The upright device may be attached to the base so that the upright device remains at the angle with respect to the base without being supported by the retaining device. The base may have a top with a plurality of channels including a first channel and a second channel. The first channel and the second channel may extend at least a majority of a width of the base, wherein the base is attached to the bottom of the upright device along the width of the base.

The base may be attached to the bottom of the upright device such that the base is at an angle of about ninety degrees with respect to the base. The apparatus may further include a tablet computer, wherein the tablet computer is configured with respect to the base, the upright device, and the retaining device, so that the tablet computer has a bottom which sits on the base, and a top which contacts the retaining device.

The retaining device may be configured to slide with respect to the upright device to change a distance of the first section from the base. The base may have a length, wherein the base is attached to the upright device along the width of the base and along a width of the upright device. The upright device may have a height which is perpendicular to the width of the upright device. The length of the base may be substantially perpendicular to the width of the base. The length of the base may be about equal to or greater than the height of the upright device.

The retaining device may include a third section connected to the second section. The third section of the retaining device may be substantially perpendicular to the second section and the third section may be elongated and have a length which is greater than the majority of the width of the base.

The retaining device may be configured to slide with respect to the upright device to change a distance of the first section from the base. Each of the first section and the second section of the retaining device may be elongated rods.

The retaining device may include a fourth section which extends over the top of the upright device and over the base and which is substantially parallel to the first section. The retaining device may include a fifth section connected to the fourth section, wherein the fifth section is substantially parallel to the second section and extends from the fourth section towards the bottom of the upright device. The second section of the retaining device may be connected to the fifth section of the retaining device by the third section of the retaining device.

In at least one embodiment, a method is provided which may include placing a bottom edge of a computer display screen on a base, wherein the computer display screen has a top edge which is opposite the bottom edge of the computer display screen; supporting the computer display screen in a first inclined orientation with respect to an upright device; and holding the computer display screen in the first inclined orientation with a retaining device. The base, the upright device, and the retaining device may be configured as previously described.

### BRIEF DESCRIPTION OF THE DRAWINGS

FIG. 1A shows a top, front, right perspective view of an apparatus in accordance with an embodiment of the present invention, with the apparatus shown in a first state;

FIG. 1B shows a top, front, left perspective view of the apparatus of FIG. 1A, with the apparatus shown in the first state;

FIG. 2A shows a bottom, front, left perspective view of the apparatus of FIG. 1A, with the apparatus shown in the first state;

FIG. 2B shows a bottom, front, right perspective view of the apparatus of FIG. 1A, with the apparatus shown in the first state;

FIG. 3A shows a top, rear, left perspective view of an apparatus identical to the apparatus of FIG. 1A, except that posts shown in FIGS. 4A-4B are not shown in FIG. 3A, with the apparatus shown in the first state;

FIG. 3B shows a top, rear, right perspective view of an apparatus identical to the apparatus of FIG. 1A, except that posts shown in FIGS. 4A-4B are not shown in FIG. 3B, with the apparatus shown in the first state;

FIG. 4A shows a top, rear, left perspective view of the apparatus of FIG. 1A, with the apparatus shown in the first state;

FIG. 4B shows a top, rear, right perspective view of the apparatus of FIG. 1A, with the apparatus shown in the first state;

FIG. 5 shows a top, front, right perspective view of the apparatus of FIG. 1A, with the apparatus shown in a second state;

FIG. 6A shows a top, front, right perspective view of the apparatus of FIG. 1A, with the apparatus shown in the first state, along with a top, front, right perspective view of a tablet computer, with the tablet computer in a first orientation with respect to the apparatus of FIG. 1A;

FIG. 6B shows a top, front, right perspective view of the apparatus of FIG. 1A, with the apparatus shown in the first state, along with a top, front, right perspective view of the tablet computer, with the tablet computer in a second orientation with respect to the apparatus of FIG. 1A;

FIG. 7A shows an apparatus in accordance with another embodiment of the present invention which includes the apparatus of FIG. 1A, and a cover, wherein FIG. 7A shows a top, rear, left perspective view of the apparatus of FIG. 1A, with the apparatus of FIG. 1A shown in the first state as in FIG. 4A, and a top, rear, left perspective view of the cover, with the cover not attached to the apparatus of FIG. 1A; and

FIG. 7B shows the apparatus of FIG. 7A wherein FIG. 7B shows a top, rear, left perspective view of the apparatus of FIG. 1A, with the apparatus of FIG. 1A shown in the first state as in FIG. 4A, and a top, rear, left perspective view of the cover, with the cover attached to the apparatus of FIG. 1A.

### DETAILED DESCRIPTION OF THE DRAWINGS

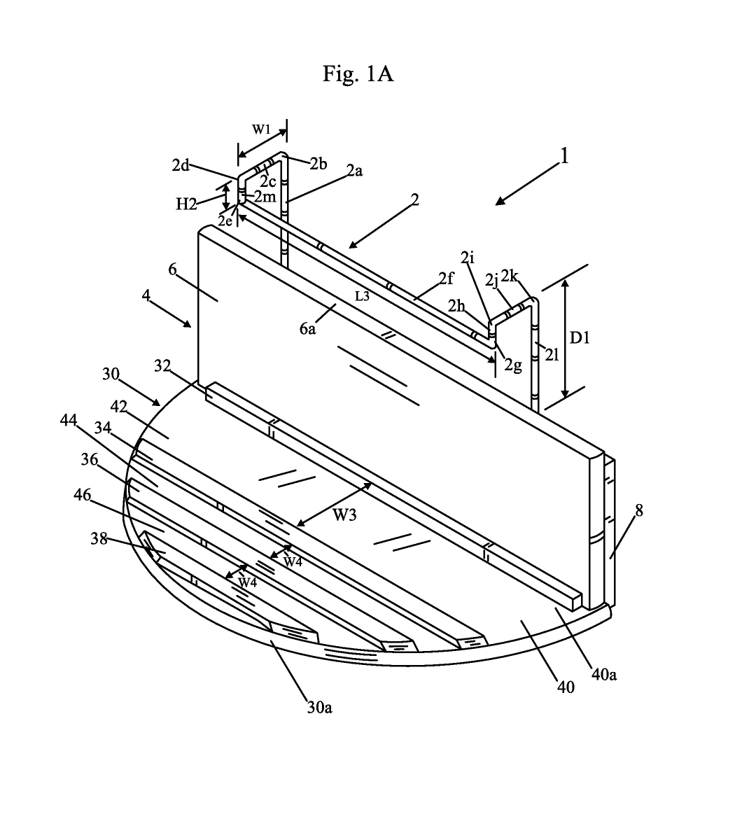

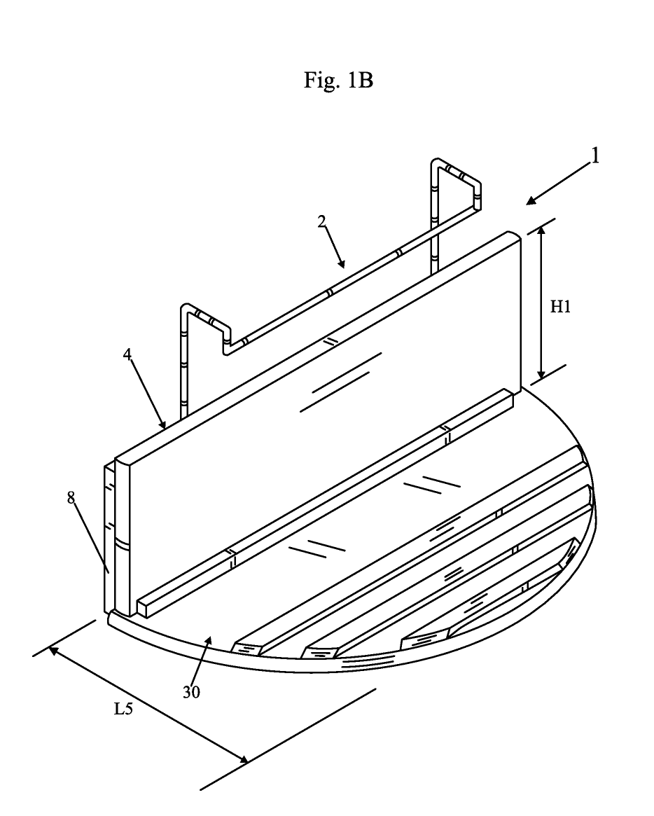

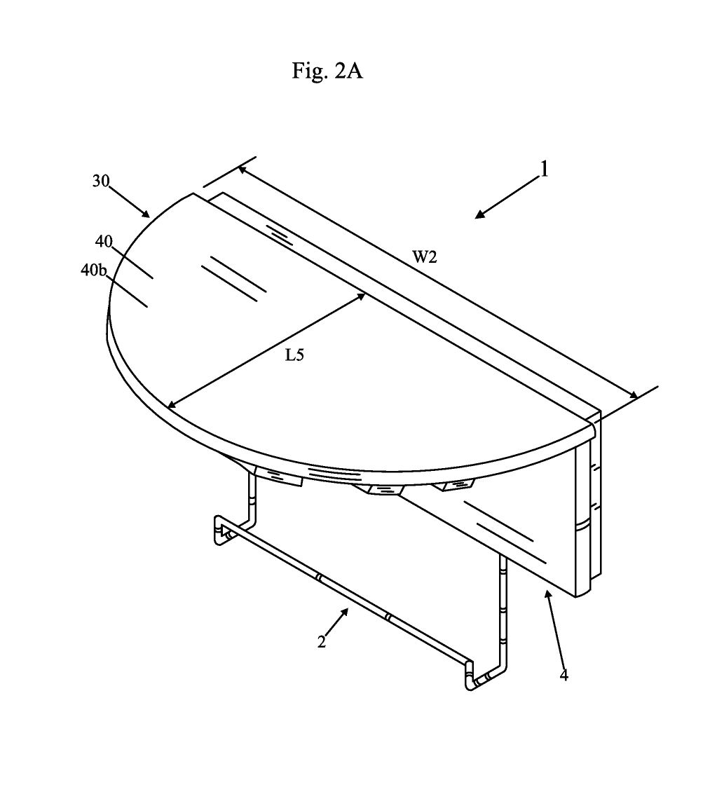

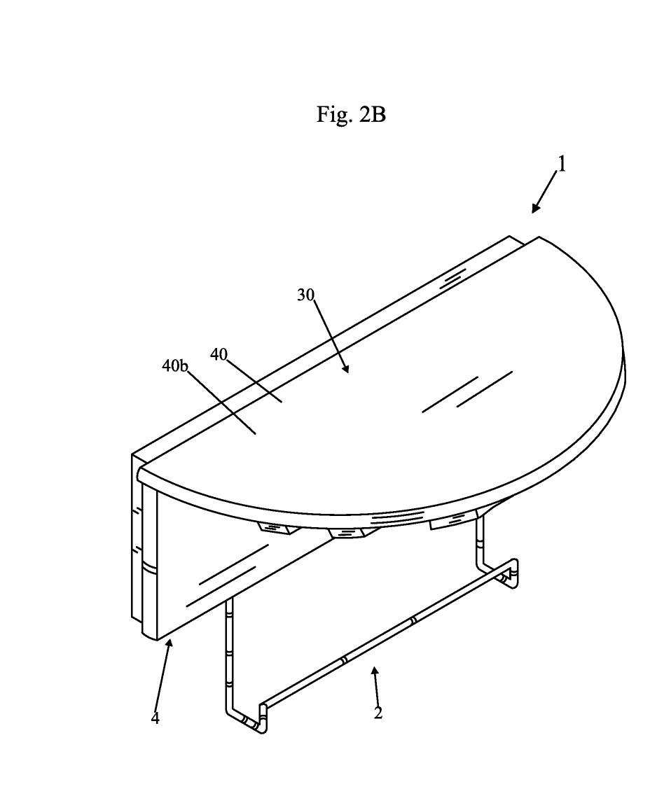

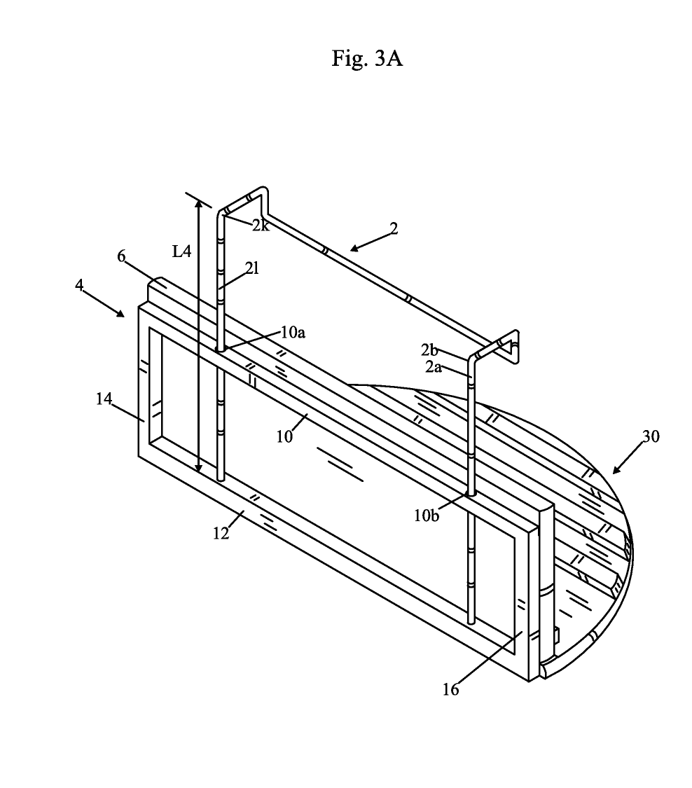

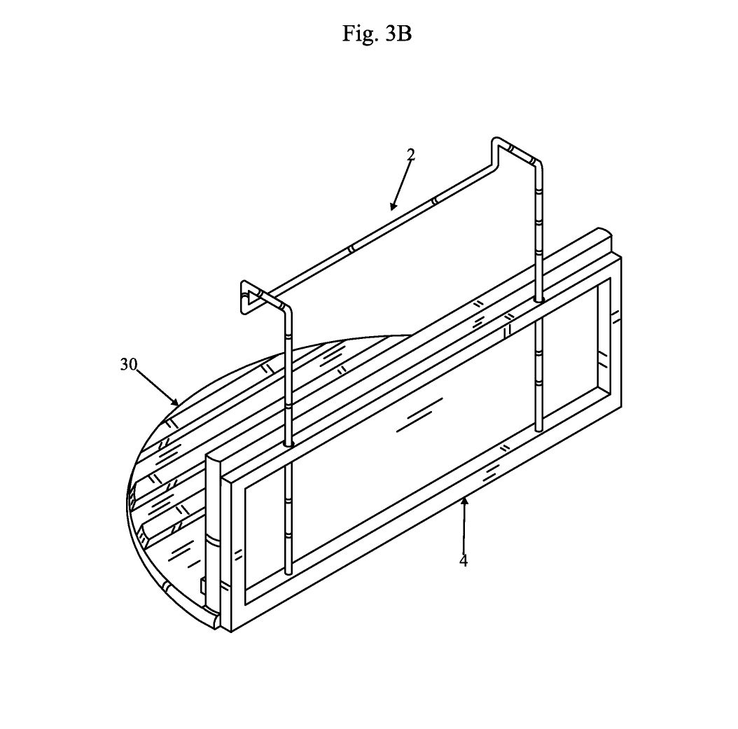

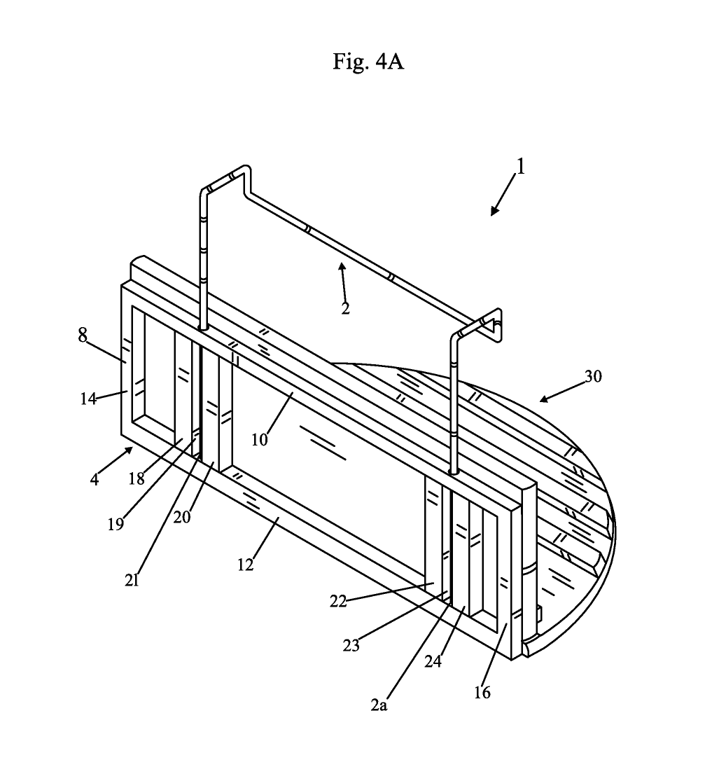

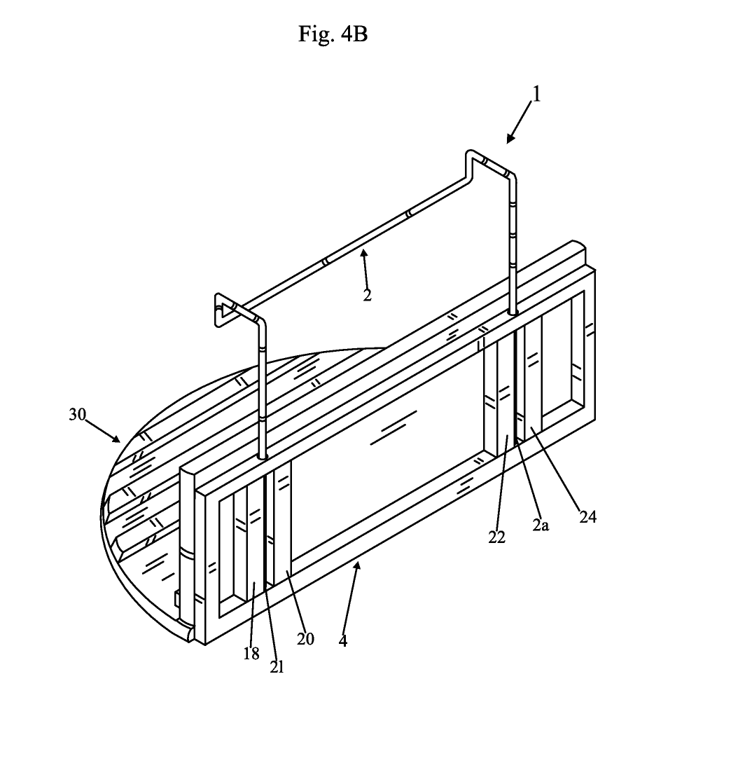

FIG. 1A shows a top, front, right perspective view of an apparatus 1 in accordance with an embodiment of the present invention, with the apparatus 1 shown in a first state. FIG. 1B shows a top, front, left perspective view of the apparatus of FIG. 1A, with the apparatus shown in the first state. FIG. 2A shows a bottom, front, left perspective view of the apparatus 1, with the apparatus 1 shown in the first state. FIG. 2B shows a bottom, front, right perspective view of the apparatus 1, with the apparatus 1 shown in the first state. FIG. 3A shows a top, rear, left perspective view of an apparatus identical to the apparatus 1, except that posts or members 18, 20, 22, and 24 shown in FIGS. 4A-4B are not shown in FIG. 3A, with the apparatus of FIG. 3A shown in the first state. FIG. 3B shows a top, rear, right perspective view of an apparatus identical to the apparatus 1, except that posts or members 18, 20, 22, and 24 shown in FIGS. 4A-4B are not shown in FIG. 3B, with the apparatus of FIG. 3A shown in the first state. FIG. 4A shows a top, rear, left perspective view of the apparatus 1, with the apparatus 1 shown in the first state. FIG. 4B shows a top, rear, right perspective view of the apparatus 1 of FIG. 1A, with the apparatus 1 shown in the first state.

Referring to FIGS. 1A-4B, the apparatus 1 includes a device or retaining device 2, a section or upright device 4, and a base 30. The device or retaining device 2 includes rods, pipes, tubes, or members 2a, 2c, 2e, 2m, 2f, 2h, 2j, and 2l. Each of rods 2a, 2c, 2e, 2f, 2h, 2j, and 2l may be circular cylindrical rods made of metal, such as steel rods. Rod 2a is connected and/or integrated with rod 2c by curved section 2b; rod 2c is connected and/or intergrated with rod 2m by curved section 2d; rod 2m is connected and/or integrated with rod 2f by curved section 2e; rod 2f is connected and/or integrated with rod 2h by curved section 2g; rod 2h is connected and/or integrated with rod 2j by curved section 2i; and rod 2j is connected and/or integrated with rod 2l by curved section 2k.

In at least one embodiment, the rods, 2a, 2l, 2m, and 2h are parallel or substantially parallel to each other. The rods 2c and 2j are parallel or substantially parallel to each other in at least one embodiment, and perpendicular or substantially perpendicular to the rod 2a. Furthermore the rod 2f may be perpendicular or substantially perpendicular to the rods 2a, 2c, and 2m. This configuration of the rods is critical in at least one embodiment to provide a satisfactory retaining feature by the device 2.

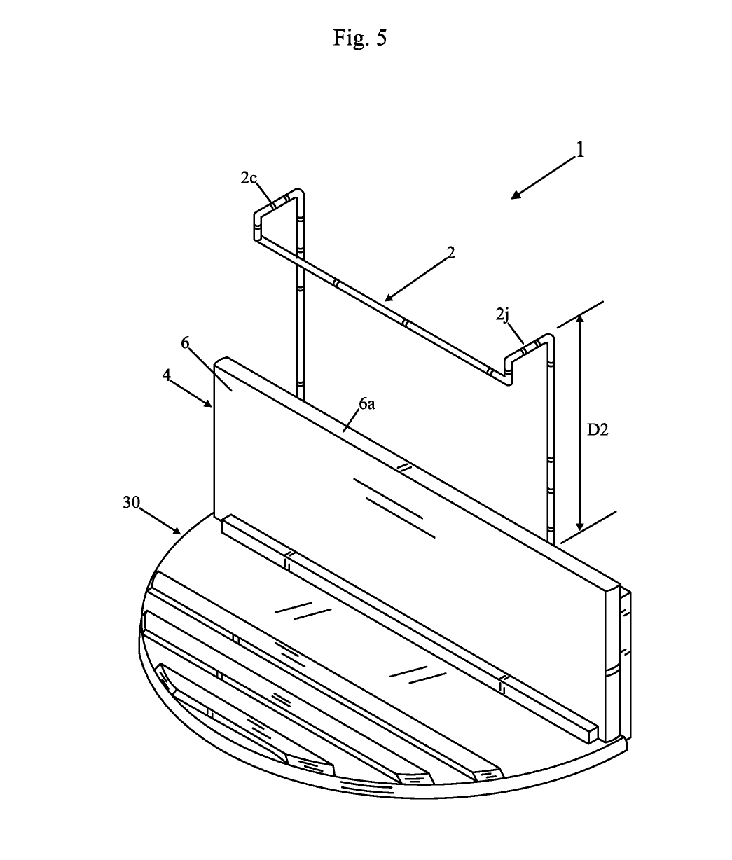

The section or upright device 4 includes a board or member 6, and a member 8, each of which may be made out of wood, hard plastic, or any other rigid material. The section or upright device 4, in at least one embodiment is perpendicular or substantially perpendicular to the rods 2l and 2a as shown in FIG. 3A. Referring to FIGS. 4A and 4B, the member 8 may include vertical members 14 and 16, and horizontal members 10 and 12. The vertical members 14 and 16 may be substantially perpendicular to, and connected and/or integrated with the the horizontal members 10 and 12. The member 8 may also include posts 18, 20, 22, and 24 shown in FIGS. 4A and 4B. As shown in FIG. 4A, the posts 18 and 20 form a channel 19, and the posts 22 and 24 form a channel 23, into which the rods 2l and 2a, respectively, of the device 2 fit and slide to adjust the height of the device 2 from the first state shown in FIG. 1A to a second state shown in FIG. 3. In FIG. 1A in the first state, a top of member 2j is a distance of D1 above a top edge 6a of the member 6. In FIG. 5, in the second state a top of member 2j is a distance of D2 above a top edge 6a of the member 6, wherein D2 is greater than D1. The device 2 can be adjusted to various heights.

The base 30 includes support or member 32 which may be fixed and/or integrated with the member 6 to connect and support the member 6 is a position which is perpendicular and/or sustantially perpendicular to the top surface 40a of the floor 40 of the base 30. The base 30 may be made of wood, metal, hard plastic, or any other rigid material. The base 30 may include ridges protrusions, or rails 34, 36, and 38. The base 30 may include slot or channel 42 between member 32 and ridge 34, slot or channel 44 between ridges 34 and 36, and slot or channel 46 between member 36 and ridge 38. The ridges 34, 36, and 38 may be fixed to and/or integrated with the floor 40 of the base 30.

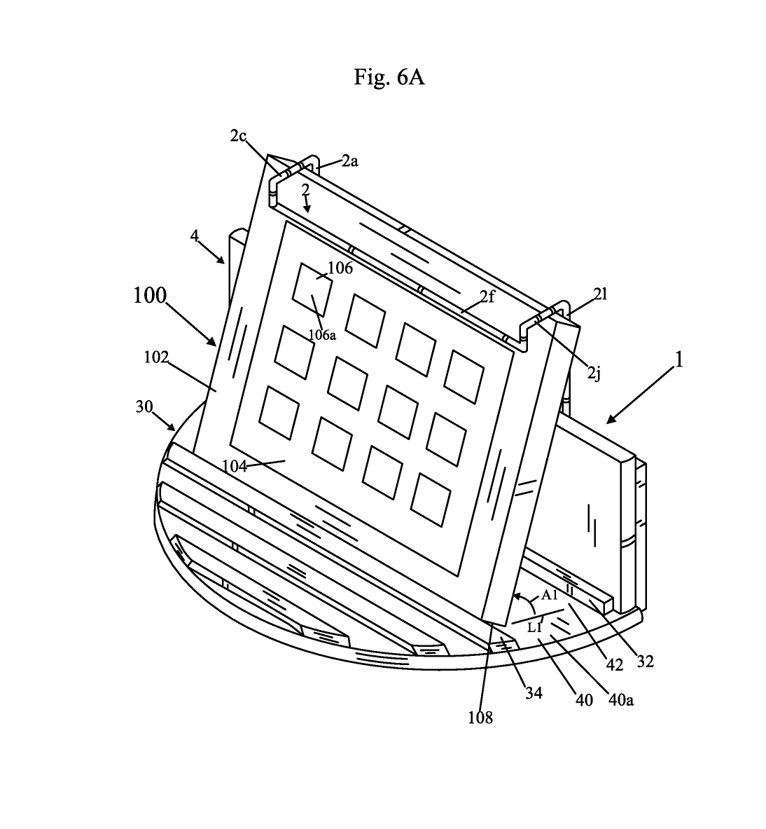

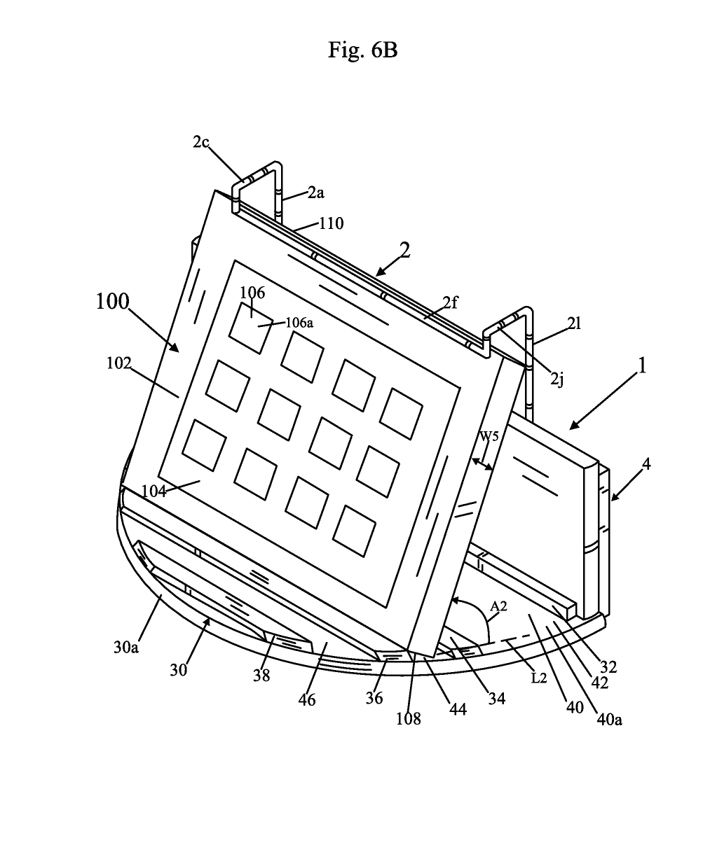

FIG. 6A shows a top, front, right perspective view of the apparatus 1, with the apparatus 1 shown in the first state, along with a top, front, right perspective view of a tablet computer 100, with the tablet computer 100 in a first orientation with respect to the apparatus 1. FIG. 6B shows a top, front, right perspective view of the apparatus 1, with the apparatus 1 shown in the first state, along with a top, front, right perspective view of the tablet computer 100, with the tablet computer 100 in a second orientation with respect to the apparatus of FIG. 1A.

The tablet computer 100 may be an IPAD (trademarked) tablet computer or any other tablet computer. The tablet computer 100 may include an outer structure, covering, and/or case 102, and a display screen and/or computer monitor 104. The tablet computer 100 may include a computer processor, computer memory, and computer interactive device, such as touch screen computer hardware and/or computer software. In FIG. 6A the screen 104 shows a plurality of icons or fields 106, including icon or field 106a. Each of the plurality of fields 106 can be selected in order to select a computer software application to executed on the tablet computer 100. In FIG. 6A, the tablet computer 100 is inclined so that it is at an angle A1 with respect to a line L1 which is parallel to the surface 40a of the floor 40 of the base 30. In addition, in FIG. 6A, the rod 2f, preferably is configured so that it does not cover the screen 104, but covers the outer structure 102 to retain the tablet computer 100 in position.

In FIG. 6A, a bottom edge 108 of the tablet computer 100 contacts ridge or protrusion 34, and the channel or slot 42 between support 32 and ridge or protrusion 34. The ridge or protrusion 34 keeps the tablet computer 100 from sliding further forward.

The device 2, may have a length L3, which includes sections 2e, 2f, and 2g, shown in FIG. 1A, wherein L3 may be about nine and five eighths inches. The device 2 may have a width W1, which includes section 2d, 2c, and 2b, wherein W1 may be about one and one quarter inches. The width W1 is critical in one or more embodiments to allow the retaining device 2 to extend a proper distance over a tablet computer, such as tablet computer 100, as shown in FIGS. 6A and 6B, so that the sections 2m and 2h which extend downwards towards the base 30 and which are connected to central elongated section 2f, through curved sections 2e and 2g respectively, can hold the tablet computer 100. The combination of sections 2d, 2m, and 2e shown in FIG. 1A may have a height H2 of three quarters of an inch. Similarly the combination of sections 2i, 2h, and 2g may have a height H2 of three quarters of an inch. In at least one embodiment, the height H2 is critical to provide an adequate retaining feature for retaining a tablet computer, such as 100 in place, but without blocking or without substantially blocking the screen 104 so that it can be viewed clearly, as shown by FIGS. 6A and 6B.

Each of the rods or sections 2a-2m may be cylindrical solid rods having a diameter of about one quarter inch. The device 2 may also have a length L4 shown in FIG. 3A, which includes members or sections 2k and 2l, which may be about eight and one quarter inches. Similarly members 2a and 2b together may have a length L4 of about eight and one quarter inches. The above dimensions in at least one embodiment are critical to provide a satisfactory retaining and viewing device for apparatus 1 for a typical tablet computer 100 such as an IPAD (trademarked) tablet computer. However other dimensions are possible in other embodiments for differently sized tablet computers or smart phones.

The rods or members 2l and 2a have been inserted through holes 10a and 10b shown in FIG. 3A, in the member 10 of the section 4. The rods or members 2l and 2a slide in the holes 10a and 10b respectively, from the first state shown in FIG. 1A to the second state shown in FIG. 5. The height of the device 2 can be adjusted to various heights from the first state of FIG. 1A to the second state of FIG. 5.

In FIG. 6B, the tablet computer 100 is in a second orientation with respect to the base 30. The tablet computer 100 is at an angle A2 with respect to a dashed line L2 which is parallel to the top surface 40a of the floor 40. The angle A2 is less than the angle A1 of FIG. 6A, such that the tablet computer 100 has been inclined further in FIG. 6B. In FIG. 6B, the bottom edge 108 of the tablet computer 100 is in contact with the ridge or protrusion 36 and the channel 44. The ridge or protrusion 36 keeps the tablet computer 100 from sliding forward towards a front edge 30a of the base 30. An edge 110 of the table computer 100, at or near the top of the tablet computer 100, in FIG. 6B, contacts the rods or members 2a and 2l, which support the tablet computer 100.

The tablet computer 100 can be adjusted to a different orientation by placing the bottom edge 108 so that it contacts channel 46 and ridge 38.

The base 30 can be placed on a person's lap, such that the bottom surface 40b shown in FIG. 2A rests on the person's lap, and the apparatus is in an upright state so that the person can view the tablet computer 100, such as one of states or orientations shown in FIGS. 6A and 6B. The base 30 can also be placed on a top of a support structure, such as a desk or a table.

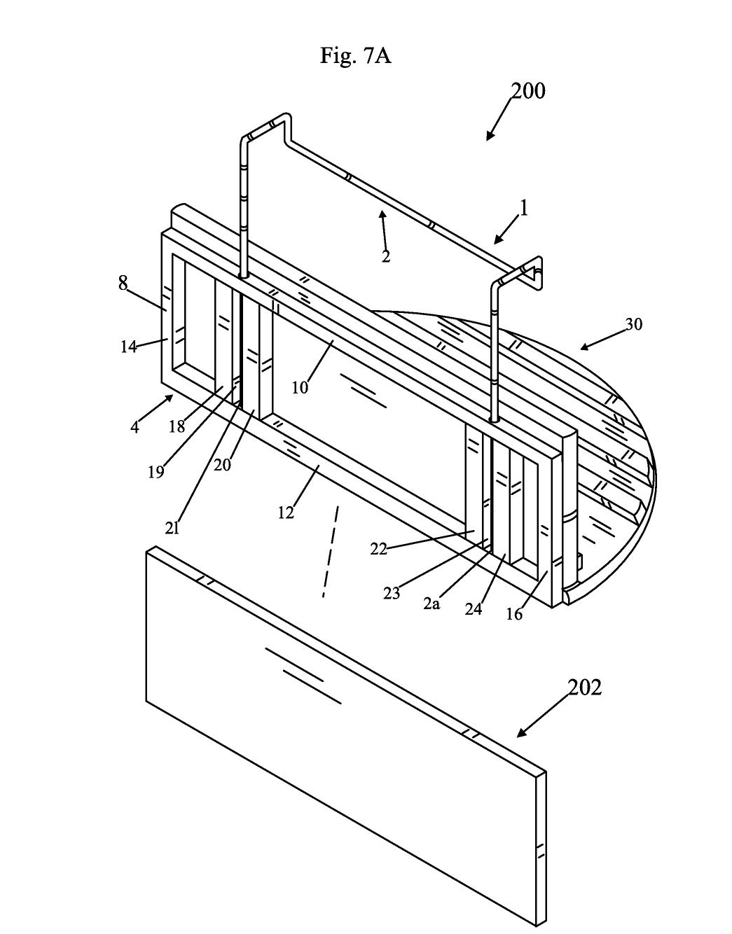

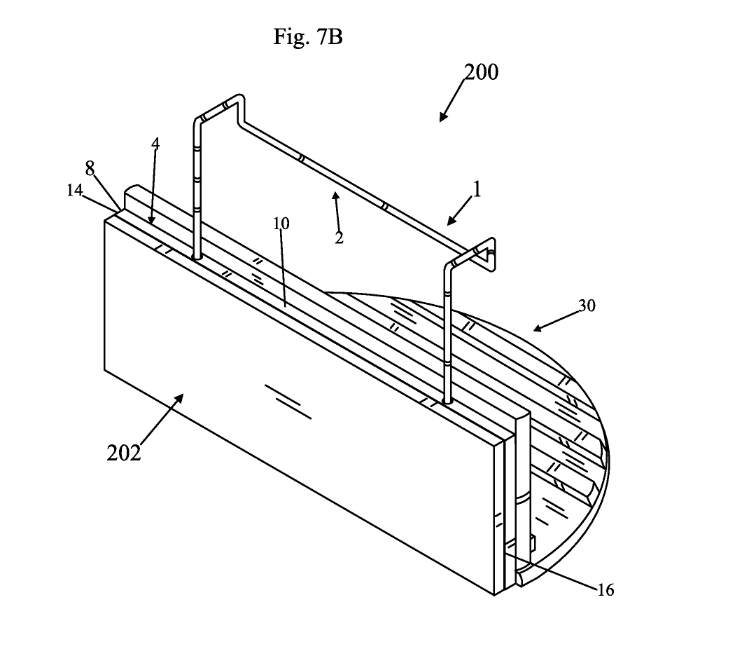

FIG. 7A shows an apparatus 200 in accordance with another embodiment of the present invention which includes the apparatus 1, and a cover 202, wherein FIG. 7A shows a top, rear, left perspective view of the apparatus 1, with the apparatus 1 shown in the first state as in FIG. 4A, and a top, rear, left perspective view of the cover 202 with the cover 202 not attached to the apparatus 1.

FIG. 7B shows a top, rear, left perspective view of the apparatus 1 in the first state as in FIG. 4A, and a top, rear, left perspective view of the cover 202, with the cover 202 attached to the apparatus 1 to form the assembled apparatus 200. The cover 202 may be attached to the section 4 by fasteners such as nails or screws, or by glue or in any other known manner. The cover 202 may be made of wood, hard plastic, or any other rigid material.

The base 30 may have a length L5, show in FIG. 2A which may be about six and three quarters inches. The base 30 may have a width W2 shown in FIG. 2A which may be about fourteen and one quarter inches. The base 30 is connected, attached, and/or fixed to the section or upright device 4 along the width W2 shown in FIG. 2A. The length L5 is perpendicular to the width W2 as shown in FIG. 2A. The upright device or section 4 has a height H1 shown in FIG. 1B which may be about four and three quarters inches. In at least one embodiment, the length L5 of the base 30 is at least about equal to or greater than the height H1 of the upright device 4. In at least one embodiment, these dimensions are critical to provide an adequate base 30 for placing on a person's lap or on a desk, and for allowing support for a typical tablet computer, such as an APPLE (trademarked) IPAD (trademarked) tablet computer.

The base 30 is shown having a semicircular shape in FIGS. 1A-7B. In at least one embodiment, the semicircular shape allows the base 30 to be placed on a desk top or lap and allows the base 30 to be turned to different vantage points while maintaining or having a smooth front surface or periphery 30a so that a there are no sharp edges to injure a person, when the person is using a tablet computer, such as 100 in FIGS. 6A and 6B, by selecting one of the plurality of icons or fields 106. While in some embodiments, the semicircular shape is critical for base 30, in other embodiments, other shapes are possible.

The channel 42 shown in FIG. 1A may have a width W3, which may be about one and three quarters inches. Each of the channels 44 and 46 shown in FIG. 1A may have a width W4 which may be three quarters of an inch. The large width for channel 42 is used to create an adequate lean or incline angle for viewing the screen 104 of the tablet computer 100. The width W4 for each of the channels 44 and 46, should be at least slightly larger than the width W5 shown in FIG. 6A of the tablet computer 100 and/or any case for the tablet computer 100, so that the tablet computer 100 and/or any case can fit and touch a top surface of the channel 44 or 46, such as shown for channel 44 in FIG. 6B.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a base;
an upright device having a top and a bottom; and
a retaining device;
wherein the base is attached to the bottom of the upright device, such that the upright device is at an angle with respect to the base;
wherein the retaining device is attached to the upright device; and
wherein the retaining device includes a first section which extends over the top of the upright device and over the base;
wherein the retaining device includes a second section connected to the first section, wherein the second section extends from the first section towards the bottom of the upright device;
wherein the upright device is attached to the base so that the upright device remains at the angle with respect to the base without being supported by the retaining device;
wherein the base has a top with a plurality of channels including a first channel and a second channel; and
wherein the first channel and the second channel extend at least a majority of a width of the base, wherein the base is attached to the bottom of the upright device along the width of the base.

2. The apparatus of claim 1 wherein
the base is attached to the bottom of the upright device such that the base is at an angle of about ninety degrees with respect to the base.

3. The apparatus of claim 1 further comprising
a tablet computer; and
wherein the tablet computer is configured with respect to the base, the upright device, and the retaining device, so that the tablet computer has a bottom which sits on the base, and a top which contacts the retaining device.

4. The apparatus of claim 1 wherein
the retaining device is configured to slide with respect to the upright device to change a distance of the first section from the base.

5. The apparatus of claim 1 wherein
wherein the base has a length, wherein the base is attached to the upright device along the width of the base and along a width of the upright device;
wherein the upright device has a height which is perpendicular to the width of the upright device;
wherein the length of the base is substantially perpendicular to the width of the base;
and wherein the length of the base is about equal to or greater than the height of the upright device.

6. The apparatus of claim 1 wherein
the retaining device includes a third section connected to the second section; and
wherein the third section of the retaining device is substantially perpendicular to the second section and the third section is elongated and a has a length which is greater than the majority of the width of the base.

7. An apparatus comprising:
a base;
an upright device having a top and a bottom; and
a retaining device;
wherein the base is attached to the bottom of the upright device, such that the upright device is at an angle with respect to the base;
wherein the retaining device is attached to the upright device; and
wherein the retaining device includes a first section which extends over the top of the upright device and over the base;
wherein the retaining device includes a second section connected to the first section, wherein the second section extends from the first section towards the bottom of the upright device;
wherein the upright device is attached to the base so that the upright device remains at the angle with respect to the base without being supported by the retaining device;
wherein the base has a length and a width, wherein the base is attached to the upright device along the width of the base and along a width of the upright device;
wherein the upright device has a height which is perpendicular to the width of the upright device;
wherein the length of the base is substantially perpendicular to the width of the base;
and wherein the length of the base is about equal to or greater than the height of the upright device.

8. The apparatus of claim 7 wherein
the base is attached to the bottom of the upright device such that the base is at an angle of about ninety degrees with respect to the base.

9. The apparatus of claim 7 further comprising
a tablet computer; and
wherein the tablet computer is configured with respect to the base, the upright device, and the retaining device, so that the tablet computer has a bottom which sits on the base, and a top which contacts the retaining device.

10. The apparatus of claim 7 wherein
the retaining device is configured to slide with respect to the upright device to change a distance of the first section from the base.

11. The apparatus of claim 1 wherein
wherein each of the first section and the second section of the retaining device are elongated rods.

12. The apparatus of claim 6 wherein
the retaining device includes a fourth section which extends over the top of the upright device and over the base and which is substantially parallel to the first section;
wherein the retaining device includes a fifth section connected to the fourth section, wherein the fifth section is substantially parallel to the second section and extends from the fourth section towards the bottom of the upright device;
and wherein the second section of the retaining device is connected to the fifth section of the retaining device by the third section of the retaining device.

13. A method comprising
placing a bottom edge of a computer display screen on a base, wherein the computer display screen has a top edge which is opposite the bottom edge of the computer display screen;
supporting the computer display screen in a first inclined orientation with respect to an upright device; and
holding the computer display screen in the first inclined orientation with a retaining device;
wherein the upright device has a top and a bottom;
wherein the base is attached to the bottom of the upright device, such that the upright device is at an angle with respect to the base;
wherein the retaining device is attached to the upright device; and
wherein the retaining device includes a first section which extends over the top of the upright device, over the top edge of the computer display screen, and over the base;
wherein the retaining device includes a second section connected to the first section, wherein the second section extends from the first section towards the bottom of the upright device;
wherein the upright device is attached to the base so that the upright device remains at the angle with respect to the base without being supported by the retaining device;
wherein the base has a top with a plurality of channels including a first channel and a second channel; and
wherein the first channel and the second channel extend at least a majority of a width of the base, wherein the base is attached to the bottom of the upright device along the width of the base.

14. The method of claim 13 wherein
the base is attached to the bottom of the upright device such that the base is at an angle of about ninety degrees with respect to the base.

15. The method of claim 13 wherein
the computer display screen is part of a tablet computer.

16. The method of claim 13 wherein
the retaining device is configured to slide with respect to the upright device to change a distance of the first section from the base.

17. The method of claim 13 wherein
wherein the base has a length, wherein the base is attached to the upright device along the width of the base and along a width of the upright device;
wherein the upright device has a height which is perpendicular to the width of the upright device;
wherein the length of the base is substantially perpendicular to the width of the base;
and wherein the length of the base is about equal to or greater than the height of the upright device.

18. The method of claim 13 wherein
the retaining device includes a third section connected to the second section; and
wherein the third section of the retaining device is substantially perpendicular to the second section and the third section is elongated and a has a length which is greater than the majority of the width of the base.

19. The method of claim 13 wherein
wherein each of the first section and the second section of the retaining device are elongated rods.

20. The method of claim 18 wherein
the retaining device includes a fourth section which extends over the top of the upright device and over the base and which is substantially parallel to the first section;
wherein the retaining device includes a fifth section connected to the fourth section, wherein the fifth section is substantially parallel to the second section and extends from the fourth section towards the bottom of the upright device;
and wherein the second section of the retaining device is connected to the fifth section of the retaining device by the third section of the retaining device.
